(19) United States
(12) Patent Application Publication
(10) Pub. No.: US 2012/0086551 A1
(43) Pub. Date: Apr. 12, 2012

(54) Headset Ear Detection

(75) Inventors: Christopher Kevan Lowe, Cambridgeshire (GB); Christopher Neville Tate, Hertfordshire (GB)

(73) Assignee: CAMBRIDGE SILICON RADIO LIMITED, Cambridge (GB)

(21) Appl. No.: 13/228,396

(22) Filed: Sep. 8, 2011

(30) Foreign Application Priority Data
Sep. 10, 2010 (GB) 1015095.1

(51) Int. Cl. G08B 5/22

(52) U.S. Cl. 340/6.1

(57) ABSTRACT

A device capable of providing information to a user through a plurality of different alerting signals, includes a sensing system capable of sensing indications that the device is in a first particular physical relationship to the user's body; an alerting system capable of conveying information to the user through a plurality of different alerting signals, the alerting signals including: a first set of alerting signals and a second set of alerting signals that are such as to be less noticeable to the user if the device is in the first particular physical relationship to the user's body than the first set of alerting signals, the device further including comprising a controller responsive to the sensing system and configured to estimate from the indications whether the device is in the first particular physical relationship to the user's body, and while it is to control the alerting system so as to suppress the provision of information to the user through the second set of alerting signals.

### BACKGROUND OF THE INVENTION

The present invention relates to providing information to the user of a device in a manner appropriate to the current physical relationship of the device to the user's body.

Aspects of the invention may relate to suppressing user alerts which may not be noticed by the user in a particular situation in favour of more appropriate user alerting signals.

Further aspects of the invention may relate to a method of adjusting the format in which the user of a device receives information from the device by detecting the device's situation with respect to the user and automatically suppressing the provision of information to the user in certain formats in dependence on the result of the detection, and apparatus for carrying out the method.

Devices such as mobile phones and portable media players are often used with peripheral devices such as hands-free or headphone headsets. For example, earpieces connected to mobile telephones via Bluetooth links may be used in order to continue a conversation over the mobile telephone network while the mobile telephone itself remains in the user's pocket or bag. These peripheral devices may provide information or alerts to the user in a number of formats. For example they may have indicator lights or small built-in screens to provide information to the user in a visual format, and/or may use the speaker in the earpiece part to provide audio information such as a beep for a low-battery alert. These devices are commonly low-power, running off small batteries.

US2008/0260176 teaches that it is possible to build sensors into headphone earpieces which can detect whether or not the earpiece is inserted into the user's ear.

A disadvantage of many Bluetooth headsets is that information is not always provided to the user in an appropriate format. Visual alerts such as indicator lights on an earpiece are not normally noticeable to the user when the earpiece is being worn. Similarly audio alerts such as beeps must be set at a volume low enough that they do not damage the wearer's hearing when the earpiece is being worn, thus are often too quiet to be heard if the earpiece has been taken off. These inappropriate alert formats may result in the user missing the information intended to be conveyed to them, and waste power in what are normally battery powered devices, decreasing the usage time available between charges.

There is a need for a device with an improved system for providing information to a user.

### SUMMARY OF THE INVENTION

According to a first aspect of the invention there is provided a device capable of providing information to a user through a plurality of different alerting signals, comprising: a sensing system capable of sensing indications that the device is in a first particular physical relationship to the user's body; an alerting system capable of conveying information to the user through a plurality of different alerting signals, the alerting signals including: a first set of alerting signals and a second set of alerting signals that are such as to be less noticeable to the user if the device is in the first particular physical relationship to the user's body than the first set of alerting signals, the device further comprising a controller responsive to the sensing system and configured to estimate from said indications whether the device is in said first particular physical relationship to the user's body, and whilst it is to control the alerting system so as to suppress the provision of information to the user through the second set of alerting signals.

The alerting signals may be such that if the device is in a second particular physical relationship to the user's body, different to the first particular physical relationship, the first set of alerting signals are less noticeable to the user than the second set of alerting signals, and the controller may be configured to estimate from the sensing data whether the device is in said second particular physical relationship to the user's body, and whilst it is to control the alerting system so as to suppress the provision of information to the user through the first set of alerting signals.

The alerting system may be for alerting the user to the occurrence of an event.

The controller may be configured to: (a) receive notice that the event has occurred, and, on receiving said notice to (b) retrieve sensing data from the sensing system, and, on retrieving said data to (c) estimate from said data whether the device is in the first particular physical relationship to the user's body, and whilst it is to control the alerting system so as to suppress the provision of information to the user through the second set of alerting signals.

The first set of alerting signals may be in a first information format and the second set of alerting signals may be in a second information format different to the first information format.

One of the information formats may be visual.

One of the information formats may be audio.

One of the information formats may be vibration.

The first and second sets of alerting signals may be in the same information formats but have different levels of intensity.

The sensing system may sample at intervals. The intervals may be within the range 0.1 to 5 seconds.

The sensing system may sample continuously.

The sensing system may sample in response to a request from the controller.

The sensing system may only sample in response to a request from the controller.

The first particular physical relationship may be proximity to the user's ear.

The alerting system may comprise an alerting element capable of providing the user with the second set of alerting signals.

The first particular physical relationship may be the device being positioned such that the first alerting element is directed away from the user.

The suppression of the provision of information to the user through the second set of alerting signals may be not providing information to the user through the second set of alerting signals at all.

The suppression of the provision of information to the user through the second set of alerting signals may be providing information to the user through the second set of alerting signals in a modified manner.

The device may be a headset.

The device may be a mobile telephone.

The device may be connected to an external device.

The sensing system may comprise a capacitive proximity detector.

The sensing system may comprise a pressure sensor.

The sensing system may use an energy pulse attenuation method.

The combinations of sets of alerting signals to be suppressed and detected physical locations of the device may be pre-set at manufacture.

The combinations of sets of alerting signals to be suppressed and detected physical locations of the device may be user-configurable.

According to a second aspect of the invention there is provided a method of providing information to the user of a device comprising the steps of: sensing indications that the device is in a particular first physical relationship to the user's body, wherein: if the device is in the first physical relationship to the user's body, a second set of alerting signals are less noticeable to the user than a first set of alerting signals, and estimating from said indications whether the device is in said particular physical relationship to the user's body, and whilst it is suppressing the provision of information to the user through the second set of alerting signals.

### BRIEF DESCRIPTION OF THE DRAWINGS

The present invention will now be described by way of example, with reference to the accompanying drawing. In the drawing:

FIG. 1 shows a schematic of how the invention could be used in a headset.

### DETAILED DESCRIPTION OF THE INVENTION

The following description is presented to enable any person skilled in the art to make and use the system, and is provided in the context of a particular application. Various modifications to the disclosed embodiments will be readily apparent to those skilled in the art.

The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

In the apparatus described below, a sensor or sensors allow the device to determine its physical location with respect to the user's body, for example in the case of an earpiece whether it is inserted in the user's ear or not. This allows the device to intelligently switch to settings which provide any information which needs to be conveyed to the user in a useful format. Thus the information has a much improved chance of being received by the user and no power is wasted on inappropriate alerts.

The device shown in the FIGURE illustrates an embodiment of the invention. A headset 1, connected wirelessly to a mobile telephone (not shown) via Bluetooth transceiver 2, comprises an earpiece 3 with sensors 4, a speaker/microphone 5, an indicator light 6 and a controller 7.

The sensors 4, which could for example include a touch sensitive area formed of an array of capacitive proximity sensors, signals the controller 7. Controller 7 is pre-programmed with logic to interpret the sensor outputs. It may do this by analysing outputs from different sensors individually, or it may combine data from multiple sensors. The sensor output signals are compared to the signals expected for the situation in which the earpiece 3 is inserted in the user's ear and the situation in which the earpiece 3 is not inserted in the user's ear. The controller 7 determines on the basis of this comparison whether the earpiece 3 has a likelihood of being located in the user's ear or not and then sends appropriate control signals to the indicator light 6 and speaker 5. In this case it may be appropriate for the indicator light 6 to be deactivated and the speaker 5 to be activated if the earpiece has been determined to be located in the user's ear. Similarly, the indicator light 6 may be activated and the speaker 5 deactivated if the earpiece has been determined not to be located in the user's ear.

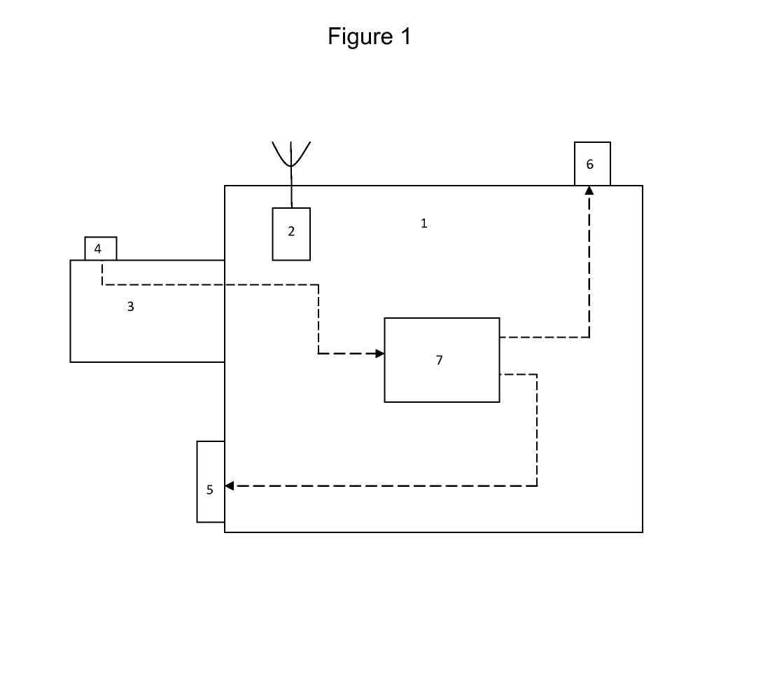

The device shown in FIG. 1 could be connected to devices other than a mobile phone. For example, the earpiece/headphone of FIG. 1 could be connected to a portable media player. In each case the connection between the peripheral device shown and the mobile telephone or portable media player could be via a wireless link such as Bluetooth or via a wired connection. A wireless link is generally more convenient for the user but a wired link may be preferred if, for example, the sensors are prone to interference from radio frequency transmissions.

The sensors could utilise various different technologies. The sensor area might be touch sensitive. This could comprise an array of capacitive proximity detectors as described above, allowing the touch sensitive area to be cleaned easily with a cloth. A cheaper alternative would be a resistive touch-screen area. The sensor area could also comprise pressure sensors, for example using strain gauges within the plastics of the device. This could provide more accurate ear recognition as the pressure pattern of an ear could be distinguished from the pressure pattern of a hand holding the earpiece. The sensor could be a light sensor which determines the earpiece to be inserted when the measured light level falls below some predetermined value. It could be a heat sensor which determines the earpiece to be inserted when it measures a temperature within the normal range of temperatures for inside a human ear. It could also use energy pulse attenuation techniques, for example emitting pulses of visible light, infrared or sound and measuring the attenuation of the reflected pulse. The sensor could be a button protruding from the earpiece which is pressed in when inserted into the user's ear.

In an alternative embodiment the device itself could be a mobile telephone. In this case the telephone could have sensors on its face to determine proximity to the user's ear. For example the existing microphone could be used for detection of echoes from audio emitted from the speaker. When the echoes indicate that the telephone is closer to the user's face than some predetermined threshold distance (that is the echoes of sound pulses emitted by the speaker are detected by the microphone quicker than a predetermined threshold time interval) audio alerts would be preferred, and when it is not visual alerts would take precedence. Alternatively, if the telephone has a touch sensitive screen this could recognise the pattern of signals produced by being held to a user's ear.

The mobile telephone could also provide information to the user via vibration. This is a more useful format than visual or audio information when the mobile telephone is in the user's pocket. Therefore if the mobile telephone is determined to be likely to be in the user's pocket (for example if a light sensor detects a very low light level) then alerts would be provided by vibration instead of beeping or flashing lights.

Generally, the device should be configured so that alerts are always provided in a format noticeable to the user, the device intelligently switching to the most useful format for that moment on the basis of the situation it has most recently detected. This increases the likelihood of the user receiving information intended for them and saves power.

In any case the sensors may sample continuously, at intervals and/or in response to a request from the controller. Continuous sampling provides accurate results while sampling at intervals or only in response to a request uses less power. The intervals may preferably be approximately one second. This is approximately the timescale on which changes in the device's situation are likely to occur so gives a good balance between the power saving provided by the discontinuous approach and the accuracy of continuous sampling. The controller could retrieve data from the sensors in response to receiving notice that an event has occurred to which the user should be alerted. This would mean that the format of each individual alert would be tailored to the situation of the device at the time. Sensing could be triggered by the controller's request for data so that no power is wasted on unnecessary sensing.

The device is capable of providing information in a plurality of formats. These could include audio, visual or touch (e.g. vibration). An example of an audio alert might be a beeping sound, which could gain the attention of the user for an urgent purpose such as answering a telephone call. For less urgent alerts, such as a text message being received, the volume of the current audio signal (e.g. music or a voice call) could be changed in a noticeable but not unpleasantly intrusive way. Audio alerts could also include pre-recorded or computer-generated messages being played through the earpiece, for example a warning that call credit is low.

Visual alerts may use indicator lights, for example LEDs (light emitting diodes). These could switch on or off; switch between steady and flashing modes or change colour in order to communicate information to the user. Visual alerts could also be provided on a screen built into the device or an external device such as a mobile telephone or portable media player to which it is connected. The screen could display text or an image, or change colour or brightness. Inexpensive, low power indicator lights may be preferable to convey simple information such as battery level, while a screen could be used to display more complex information.

Other information formats may also be used, for example vibration is a useful format when a device is in a pocket and cannot be seen or heard, or the user has impaired vision or hearing.

There may be different types of alerting signal available which use the same information format, some of which could be more useful than others for a particular situation. For example, the speaker may be capable of emitting alerting beeps at different volume levels. In this case the device could be configured to alert the user with a low volume beep when sensed to be in the user's ear, and a higher volume beep when sensed to be elsewhere. Similarly, the device could have different vibration strength levels and may be capable of distinguishing between when it is touching the user's skin, in which case a low strength vibration alert could be used, and when it is touching fabric, for example of the interior of a pocket or a handbag, when a higher strength vibration would be appropriate.

The settings adopted on detection of the situation of the device may be preset by the manufacturer, allowing the user to benefit from this functionality of the device immediately. Alternatively, or additionally, they could be selectable by the user allowing them more choice to suit their individual preferences.

The detection results could be used to control other features than user alerts. The noise suppression and echo cancellation commonly employed by such devices could be improved using the sensing and control system. If the device is a mobile telephone then when a call is in progress the volume of the speaker could be automatically adjusted based on the distance between the telephone and the user's ear, so that the user moving the phone away from their ear (so that others could listen or the user could see the screen) would cause an automatic switch to a “speakerphone mode” with higher speaker volume and microphone sensitivity and appropriate noise suppression, without the user having to find a control such as a small button.

One or more forms of alerting may be suppressed dependent on the estimated physical relationship between the unit that is capable of performing the alerting (e.g. the headset unit) and the body of a user. Examples of the estimated relationship that may trigger the suppression of an alert include: the unit or part of it being inserted in or located adjacent to one of the user's ears, the unit being attached around one of the user's wrists or arms, the unit being located in the user's clothing or in an accessory such as a handbag, or the unit being located on a horizontal surface (e.g. a table top) which can be assumed to be somewhat remote from the user's body. The suppression could also be in response to the alerting device facing away from the user, for example if the screen of a mobile telephone was sensed to be directed away from the user then it could be dimmed or switched off, or could simply not be selected for alerting the user to an event.

Suppressing a form of alert could mean not providing it at all, which could be accomplished by switching off the alerting element which provides that form of alert. For example suppressing visual alerts provided by a screen could mean switching off the screen. Alternatively, suppressing a form of alert could mean providing it in a manner which uses less power. For example the screen could still display an alert, but without switching on the backlight. This could be useful if, for example, the alert involved conveying a complex message which may be difficult for the user to comprehend in a one-time audio alert and would be more suitably displayed as on-screen text which could be read repeatedly. Then if the device was positioned such that the screen was not visible to the user an audio alert could sound to encourage the user to look at the screen.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A device capable of providing information to a user through a plurality of different alerting signals, comprising:
a sensing system capable of sensing indications that the device is in a first particular physical relationship to the user's body;
an alerting system capable of conveying information to the user through a plurality of different alerting signals, the alerting signals including:
a first set of alerting signals and
a second set of alerting signals that are such as to be less noticeable to the user if the device is in the first particular physical relationship to the user's body than the first set of alerting signals,
the device further comprising a controller responsive to the sensing system and configured to estimate from said indications whether the device is in said first particular physical relationship to the user's body, and whilst it is to control the alerting system so as to suppress the provision of information to the user through the second set of alerting signals.

2. A device as claimed in claim 1,
the alerting signals being such that if the device is in a second particular physical relationship to the user's body, different to the first particular physical relationship, the first set of alerting signals are less noticeable to the user than the second set of alerting signals, and
the controller being configured to estimate from the sensing data whether the device is in said second particular physical relationship to the user's body, and whilst it is to control the alerting system so as to suppress the provision of information to the user through the first set of alerting signals.

3. A device as claimed in claim 1 wherein the alerting system is for alerting the user to the occurrence of an event.

4. A device as claimed in claim 3 wherein the controller is configured to: (a) receive notice that the event has occurred, and, on receiving said notice to (b) retrieve sensing data from the sensing system, and, on retrieving said data to (c) estimate from said data whether the device is in the first particular physical relationship to the user's body, and whilst it is to control the alerting system so as to suppress the provision of information to the user through the second set of alerting signals.

5. A device as claimed in claim 1 wherein the first set of alerting signals are in a first information format and the second set of alerting signals are in a second information format different to the first information format.

6. A device as claimed in claim 5 wherein one of the information formats is visual.

7. A device as claimed in claims 5 wherein one of the information formats is audio.

8. A device as claimed in claim 5 wherein one of the information formats is vibration.

9. A device as claimed in claim 1 wherein the first and second sets of alerting signals are in the same information formats but have different levels of intensity.

10. A device as claimed in claim 1 wherein the sensing system samples at intervals.

11. A device as claimed in claim 10 wherein the intervals are within the range 0.1 to 5 seconds.

12. A device as claimed in claim 1 wherein the sensing system samples continuously.

13. A device as claimed in claim 1 wherein the sensing system samples in response to a request from the controller.

14. A device as claimed in claim 13 wherein the sensing system only samples in response to a request from the controller.

15. A device as claimed in claim 1 wherein the first particular physical relationship is proximity to the user's ear.

16. A device as claimed in claim 1 wherein the alerting system comprises an alerting element capable of providing the user with the second set of alerting signals.

17. A device as claimed in claim 16 wherein the first particular physical relationship is the device being positioned such that the first alerting element is directed away from the user.

18. A device as claimed in claim 1 wherein the suppression of the provision of information to the user through the second set of alerting signals is not providing information to the user through the second set of alerting signals at all.

19. A device as claimed in claim 1 wherein the suppression of the provision of information to the user through the second set of alerting signals is providing information to the user through the second set of alerting signals in a modified manner.

20. A device as claimed in claim 1 wherein the device is a headset.

21. A device as claimed in claim 1 wherein the device is a mobile telephone.

22. A device as claimed in claim 1 wherein the device is connected to an external device.

23. A device as claimed in claim 1 wherein the sensing system comprises a capacitive proximity detector.

24. A device as claimed in claim 1 wherein the sensing system comprises a pressure sensor.

25. A device as claimed in claim 1 wherein the sensing system uses an energy pulse attenuation method.

26. A device as claimed in claim 1 wherein the combinations of sets of alerting signals to be suppressed and detected physical locations of the device are pre-set at manufacture.

27. A device as claimed in claim 1 wherein the combinations of sets of alerting signals to be suppressed and detected physical locations of the device are user-configurable.

28. A method of providing information to the user of a device comprising the steps of:
sensing indications that the device is in a particular first physical relationship to the user's body, wherein:
if the device is in the first physical relationship to the user's body, a second set of alerting signals are less noticeable to the user than a first set of alerting signals, and
estimating from said indications whether the device is in said particular physical relationship to the user's body, and whilst it is suppressing the provision of information to the user through the second set of alerting signals.
